(19) United States
(12) Patent Application Publication
(10) Pub. No.: US 2006/0220998 A1
(43) Pub. Date: Oct. 5, 2006

(54) Plasma display panel and plasma display device

(76) Inventors: Takashi Sasaki, Hiratsuka (JP); Takayuki Kobayashi, Machida (JP); Naoki Itokawa, Kawasaki (JP); Akira Otsuka, Zama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/393,766

(22) Filed: Mar. 31, 2006

(30) Foreign Application Priority Data
Mar. 31, 2005 (JP) JP2005-101331

(51) Int. Cl. G09G 3/28

(52) U.S. Cl. 345/67

(57) ABSTRACT

A plasma display panel in which firing voltages between any of electrodes are low can be realized. A plasma display panel has a first substrate and a second substrate. The first substrate has a group of laterally extending first electrodes for performing sustain discharge and a group of laterally extending second electrodes which can be independently driven, a group of third electrodes positioned between the first and second electrodes, a dielectric layer covering-them, a group of fourth electrodes extending vertically and provided on the dielectric layer, and a protective layer. The second substrate has barrier ribs provided in parallel to the fourth electrodes so as to divide at least the first to third electrodes in the extending directions, and phosphors for emitting light when excited by an ultraviolet ray.

### CROSS-REFERENCE TO RELATED APPLICATION

The present application claims priority from Japanese Patent Application No. JP 2005-101331 filed on Mar. 31, 2005, the content of which is hereby incorporated by reference into this application.

### TECHNICAL FIELD OF THE INVENTION

The present invention relates to an A/C plasma display panel (PDP) and a plasma display device (PDP device) used for a display device of a personal computer and a workstation, a flat TV, and a plasma display for displaying advertisements, information, and others.

### BACKGROUND OF THE INVENTION

In AC color PDP devices, an address/display separation (ADS) method in which a period when the cells to be displayed are determined (address period) and a display period when discharges for display lighting are performed (sustain discharge period) are separated has been widely employed. In this method, charge is accumulated in the cells, which are to be lit, in the address period, and discharges for display are performed by utilizing the charge in the sustain discharge period.

Also, plasma display panels include: a two-electrode type PDP in which a plurality of first electrodes extending in a first direction are provided in parallel to each other and a plurality of second electrodes extending in a second direction which is perpendicular to the first direction are provided in parallel to each other; and a three-electrode type PDP in which a plurality of first electrodes and second electrodes extending in a first direction are alternately provided in parallel to each other and a plurality of third electrodes extending in a second direction perpendicular to the first direction are provided in parallel to each other. In recent years, the three-electrode type PDPs have been widely used.

In a general structure of the three-electrode type PDPs, first (X) electrodes and second (Y) electrodes are alternately provided in parallel to each other on a first substrate, address electrodes extending in a direction which is perpendicular to the extending direction of the X and Y electrodes are provided on a second substrate opposite to the first substrate, and the surfaces of the electrodes are covered by a dielectric layer. On the second substrate, barrier ribs which are extending in one direction and arranged in stripes between the address electrodes in parallel to the address electrodes or barrier ribs which are arranged in lattice pattern and disposed in parallel to the address electrodes and the X and Y electrodes so as to individually separate the cells are further provided, and the first and the second substrates are bonded to each other after phosphor layers are formed between the barrier ribs. Therefore, the dielectric layer and the phosphor layers and further the barrier ribs are formed on the address electrodes.

After the charge (wall charge) in the vicinity of the electrodes of all cells is made uniform by applying voltage between the X and Y electrodes, the addressing operation for selectively leaving the wall charge in the cells to be lit is performed by sequentially applying scan pulses to the Y electrodes and applying address pulses to the address electrodes in synchronization with the scan pulses. Subsequently, sustain discharge pulses which alternately change the polarities of the adjacent two electrodes are applied to the X and Y electrodes where discharges are to be performed. By doing so, the sustain discharges are generated in the cells to be lit in which the wall charge has been formed through the addressing operation, thereby performing the lighting. The phosphor layers emit light by ultraviolet rays generated through the discharges, and the light is seen through the first substrate. Therefore, the X and Y electrodes are comprised of opaque bus electrodes formed of metal materials and discharge electrodes such as ITO films, and the light generated in the phosphor layers can be seen through the discharge electrodes. Since structures and operations of general PDPs are widely known, detailed descriptions thereof will be omitted here.

In the field of the above-described three-electrode type PDP, various types of PDPs in which third (Z) electrodes are respectively provided between the X electrodes and Y electrodes in parallel thereto have been proposed.

For example, Japanese Patent Application Laid-Open Publication No. 2001-34228 (Patent Document 1) discloses the structure in which Z electrodes are provided between X electrodes and Y electrodes where discharge is not performed (non-display line) so that the Z electrodes are utilized for trigger operations, prevention of discharges in non-display lines (prevention of reverse slit), reset operations, and others.

Moreover, Japanese Patent Application Laid-Open Publication No. 2004-273265 (Patent Document 2) discloses an example in which the X and Y electrodes and the address electrodes are provided on the first substrate (front substrate). In addition, the present applicant has disclosed an example in which the X and Y electrodes and the address electrodes are provided on the first substrate (front substrate) in Japanese Patent Application No. 2004-135321 (application based on the domestic priority of Japanese Patent Application No. 2003-326440).

### SUMMARY OF THE INVENTION

In recent years, reduction in power consumption of PDP devices has been demanded, and in order to improve light emission efficiency, the concentration of xenon (Xe) in the discharge gas is increased. However, when the concentration of xenon (Xe) in the discharge gas is increased, the firing voltages between the Y electrodes on the first substrate (front substrate) and the address electrodes on the second substrate (rear substrate) are increased. Therefore, since the driving circuits of the Y electrodes and the address electrodes have to output high voltages, a problem that the cost of the driving circuits is increased occurs. In other words, it is required that the firing voltages between the Y electrodes and the address electrodes are kept low even when the concentration of xenon (Xe) in the discharge gas is increased.

Meanwhile, it is also required to reduce the firing voltages between the first (X) electrodes and the second (Y) electrodes so as to reduce the output voltages of the driving circuits of the X electrodes and the Y electrodes.

An object of the present invention is to realize a plasma display panel in which the firing voltages between any of the electrodes are low.

In order to achieve the above-described object, in a plasma display panel (PDP) of the present invention, first (X), second (Y), third (Z), and fourth (address) electrodes for performing the discharge are formed on a substrate of one side.

More specifically, a plasma display panel (PDP) according to the present invention comprises: a first substrate; a second substrate; and discharge gas filled between the first and second substrates, wherein the first substrate includes: a group of first electrodes for performing sustain discharge and a group of second electrodes which can be independently driven, the first and second electrodes being alternately disposed approximately in parallel to each other; a group of third electrodes located between the first and second electrodes; a dielectric layer covering the groups of the first to third electrodes; a group of fourth electrodes provided on the dielectric layer so as to intersect with the first to third electrodes; and a protective layer provided so as to cover the dielectric layer and the group of the fourth electrodes, and the second substrate includes: barrier ribs provided in parallel to the fourth electrode so as to divide at least the first to third electrodes in the extending direction thereof; and phosphors for emitting light when excited by ultraviolet rays.

In the PDP of the present invention, since all of the four kinds of electrodes for performing the discharge are provided on the first substrate (front substrate), it is not necessary to perform the discharge between the electrodes provided on opposite substrates. Therefore, the distance between the electrodes for performing the discharge can be reduced, and the firing voltage can be reduced.

The first (X) electrode is comprised of a first discharge electrode through which visible light can pass and a first bus electrode having an electrical resistance value lower than that of the first discharge electrode, and the second electrode is comprised of a second discharge electrode through which visible light can pass and a second bus electrode having an electrical resistance value lower than that of the second discharge electrode.

The groups of the first and second electrodes and the group of the third electrodes are disposed on the same plane.

The barrier ribs are provided so as to cover portions where the first bus electrode, the second bus electrode, and the third electrode intersect with the fourth electrode and vicinities of the portions.

The first discharge electrode, the second discharge electrode, and the third electrode have the same shape in each cell. Also, the distances from the first discharge electrode and the second discharge electrode to the third electrode are gradually varied in each cell. Consequently, variation in the firing voltage due to variation in edge distances can be reduced.

A minimum distance from the first discharge electrode and the second discharge electrode to the third electrode in each cell is desirably 50 μm or less, a maximum distance from the first discharge electrode and the second discharge electrode to the third discharge electrode in each cell is desirably 100 μm or more, and a product of pressure of the filled discharge gas and the minimum distance is desirably larger than Paschen minimum.

When discharge gas is filled in a discharge space and discharge is to be generated between two electrodes like a PDP, it is known that the discharge threshold voltage (firing voltage) is determined in accordance with the product of the distance between the two electrodes and the pressure of the discharge gas, and a curve representing the variation thereof on a graph with the product as the horizontal axis and the firing voltage as the vertical axis is called the Paschen curve. The Paschen curve takes a minimum value when the product of the distance between the two electrodes and the pressure of the discharge gas is a certain value, and this state is called the Paschen minimum.

A minimum distance from the first discharge electrode and the second discharge electrode to the third electrode in each cell is desirably positioned on a side where the fourth electrode in the cell is disposed.

The distance between the second discharge electrode and the fourth electrode is desired to be narrower than the distances from the first discharge electrode and the second discharge electrode to the third electrode. By doing so, in an addressing operation, even when the voltages applied to the second electrode and the fourth (address) electrode are reduced, discharge is generated between the second electrode and the fourth electrode, and this discharge triggers a shift to the discharge between the second electrode and the first electrode.

The dielectric layer covering the groups of the first to third electrodes is desired to be composed of a silicon compound which is formed through a vapor deposition process. The dielectric layer formed through a vapor deposition process has a flat and smooth surface and is stable and thin. Therefore, the fourth (address) electrode can be readily formed thereon. Furthermore, since the dielectric layer formed through a vapor deposition process has a small dielectric constant, the inter-electrode capacitance is small, and the driving can be facilitated.

The first and second substrates are rectangles, and the long sides and the short sides of the second substrate are shorter than the long sides and the short sides of the first substrate, respectively.

The discharge gas contains at least neon (Ne) and xenon (Xe), and the mixing ratio of xenon is desirably 10 percent or more. Consequently, luminance can be improved. In addition, since the fourth (address) electrode is formed on the first substrate on which the second (Y) electrode is also formed, the voltage for generating the address discharge can be reduced.

The third (Z) electrode operates as a trigger electrode when discharge is to be repeated between the first (X) electrode and the second (Y) electrode in a sustain discharge period. Therefore, in the sustain discharge period, in synchronization with application of voltages to the groups of the first and second electrodes, the voltage which generates the discharge between the group of the third electrodes and the group of the first electrodes or between the group of the third electrodes and the group of the second electrodes is applied to the group of the third electrodes in order to repeat the discharge between the group of the first electrodes and the group of the second electrodes. Consequently, main discharge for displaying is performed between the first discharge electrode and the second discharge electrode where light emission efficiency is good. More specifically, when sustain discharge is to be performed between the first electrode and the second electrode, at the same time as or earlier than the application of a sustain discharge voltage between the first electrode and the second electrode, a predetermined voltage is applied between the third electrode and either the first electrode or the second electrode. By doing so, the discharge is generated between the first electrode or the second electrode and the third electrode, and this discharge triggers the sustain discharge between the first electrode and the second electrode. Immediately after the sustain discharge occurs between the first electrode and the second electrode, the voltage applied to the third electrode is switched to apply a predetermined voltage between the third electrode and the other of the first electrode and the second electrode, thereby stopping the discharge between the first electrode or the second electrode and the third electrode.

The structure of the present invention can be applied to both the general three-electrode type PDP in which discharge is performed between a pair of the first electrode and the second electrode and the so-called ALIS-type PDP described in Japanese Patent No. 2801893 (Patent Document 3). When the present invention is applied to the general three-electrode type PDP, the third (Z) electrode is disposed between the first electrode and the second electrode where discharge is to be performed. When the present invention is applied to the ALIS-type PDP, the third (Z) electrodes are disposed between all of the first electrodes and the second electrodes and are divided into four groups in accordance with the disposed positions, and a common voltage is applied to each group.

According to the present invention, the plasma display panel in which the firing voltages between any of the electrodes are low can be realized. Therefore, output voltages of driving circuits of a plasma display device (PDP device) having the plasma display panel can be reduced, thereby reducing the cost thereof.

### BRIEF DESCRIPTIONS OF THE DRAWINGS

FIG. 1 is a diagram showing the entire structure of a PDP device of a first embodiment of the present invention;

FIG. 2 is an exploded perspective view of the PDP of the first embodiment;

FIG. 3A is a cross-sectional view of the PDP of the first embodiment;

FIG. 3B is a cross-sectional view of the PDP of the first embodiment;

FIG. 4 is a diagram showing the shapes of electrodes of the first embodiment;

FIG. 5 is a diagram showing the shapes of substrates of the first embodiment;

FIG. 6 is a diagram showing the structure of the rear substrate of the first embodiment;

FIG. 7 is a graph for explaining principles of the present invention;

FIG. 8 is a diagram showing driving waveforms of the first embodiment;

FIG. 9 is a diagram showing a modification example of barrier ribs;

FIG. 10 is a diagram showing a modification example of the structure of the rear substrate;

FIG. 11 is a diagram showing the entire structure of a PDP device of a second embodiment of the present invention;

FIG. 12 is a diagram showing the shapes of the electrode of the second embodiment;

FIG. 13 is a diagram showing driving waveforms (odd-number field) of the second embodiment; and

FIG. 14 is a diagram showing driving waveforms (even-number field) of the second embodiment.

### DESCRIPTIONS OF THE PREFERRED EMBODIMENTS

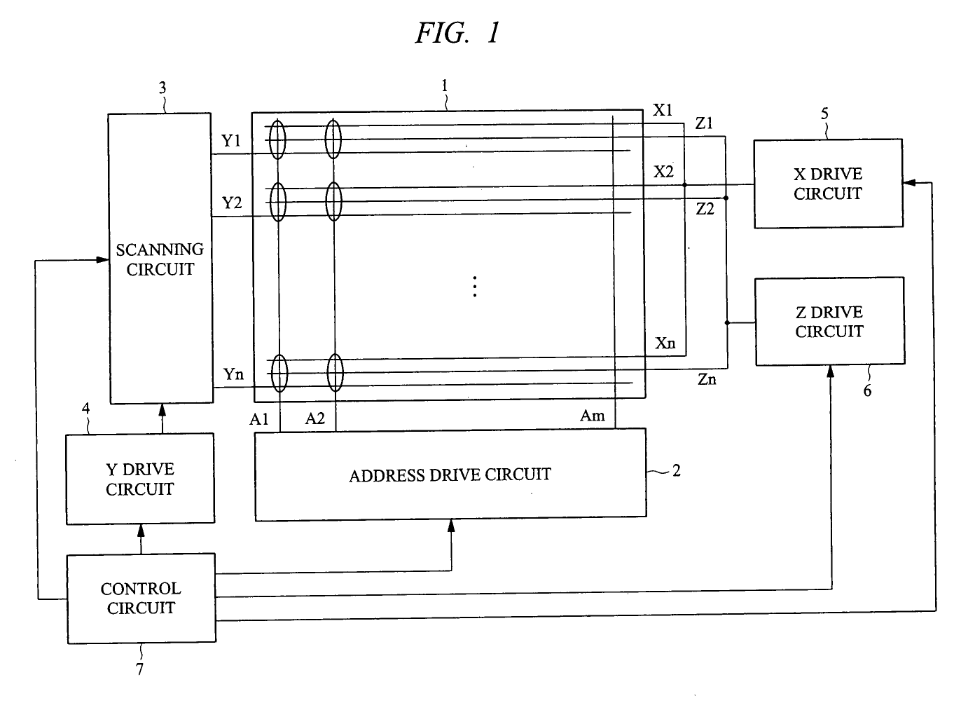

FIG. 1 is a diagram showing the entire structure of a plasma display device (PDP device) of a first embodiment of the present invention. A PDP 1 used in the PDP device of the first embodiment is obtained by applying the present invention to a conventional PDP in which a discharge is performed between a pair of a first (X) electrode and a second (Y) electrode. As shown in FIG. 1, in the PDP 1 of the first embodiment, laterally extending X electrodes X1, X2, . . . , Xn and Y electrodes Y1, Y2, . . . , Yn are alternately disposed, and each of third electrodes Z1, Z2, . . . , Zn is disposed between the X electrode and the Y electrode of each pair. Therefore, n sets of three electrodes, that is, the X electrode, the Y electrode, and the Z electrode are formed. In addition, vertically extending fourth (address) electrodes A1, A2, . . . , Am are disposed so as to intersect with the n sets of the X electrodes, the Y electrodes, and the Z electrodes, and cells are formed at the intersecting parts. Therefore, n display rows and m display columns are formed.

As shown in FIG. 1, the PDP device of the first embodiment has an address driving circuit 2 which drives the m lines of address electrodes, a scanning circuit 3 which applies scan pulses to the n lines of Y electrodes, a Y driving circuit 4 which applies voltages other than the scan pulses to the n lines of Y electrodes in common via the scanning circuit 3, an X driving circuit 5 which applies voltages to the n lines of X electrodes in common, a Z driving circuit 6 which applies voltages to the n lines of Z electrodes in common, and a control circuit 7 which controls each of the circuits. The PDP device of the first embodiment is different from the conventional examples in that the panel structure of the PDP 1 is modified, the Z electrodes are provided in the PDP 1, and the Z driving circuit 6 which drives them is provided, and other parts are the same as the conventional examples. Therefore, only the parts relating to the panel structure and the Z electrodes will be described here, and descriptions of other parts will be omitted.

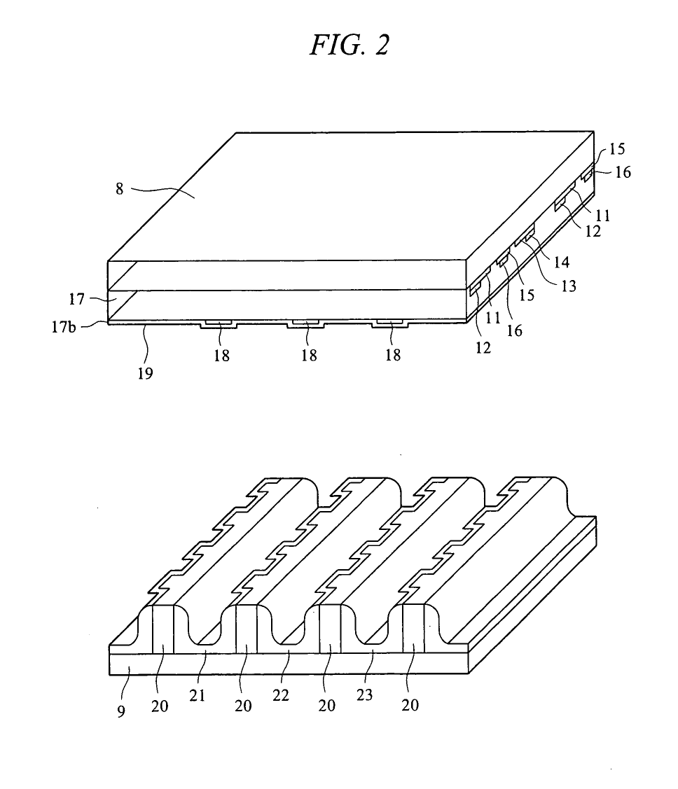

FIG. 2 is an exploded perspective view of the PDP of the first embodiment. As shown in FIG. 2, on a front (first) glass substrate 8, laterally extending first (X) bus electrodes 12 and second (Y) bus electrodes 14 are alternately disposed in parallel to each other so as to form pairs. X and Y optically transparent electrodes (discharge electrodes) 11 and 13 are provided so as to be overlapped over the X and Y bus electrodes 12 and 14, and parts of the X and Y discharge electrodes 11 and 13 are extending toward the side of the opposing electrodes. A third (Z) discharge electrode 15 and a third (Z) bus electrode 16 overlapped with each other are provided between the X and Y bus electrodes 12 and 14 of each pair. For example, the bus electrodes 12, 14, and 16 are formed of metal layers and the discharge electrodes 11, 13, and 15 are formed of ITO films or the like, and the resistance values of the bus electrodes 12, 14, and 16 are lower than or equal to the resistance values of the discharge electrodes 11, 13, and 15. Hereinafter, the parts of the X and Y discharge electrodes 11 and 13 extending from the X and Y bus electrodes 12 and 14 will be simply referred to as X and Y discharge electrodes 11 and 13, respectively, and the third (Z) discharge electrode 15 and the third (Z) bus electrode 16 will be together referred to as a third (Z) electrode.

On the discharge electrodes 11, 13, and 15 and the bus electrodes 12, 14, and 16, a dielectric layer 17 is formed so as to cover the electrodes. The dielectric layer 17 is composed of a SiO₂ film or the like through which visible light can pass, and formed by means of a vapor deposition method. Note that, as the manufacturing method of the dielectric layer 17, the CVD method, particularly, the plasma CVD method is suitable among vapor deposition methods.

Fourth (address) electrodes 18 are provided on the dielectric layer 17 so as to intersect with the bus electrodes 12, 14, and 16. For example, the address electrodes 18 are formed of metal layers. At this time, when the address electrodes 18 are to be formed, since the surface of the dielectric layer 17 formed by a vapor deposition method is flat and smooth, the electrodes can be readily formed thereon. Moreover, since the dielectric layer 17 is not eroded by a wet etchant other than hydrofluoric acid, the dielectric layer is not deteriorated even in the process for forming the electrode pattern. Furthermore, since the dielectric layer 17 formed by a vapor deposition method is thinner than a general dielectric layer formed through the annealing, the dielectric layer 17 is level, and the electrodes can be readily formed also in terms of this point. Moreover, the dielectric constant is also as low as one third of that of a general lead-based low-melting-point glass, and the capacitance is not largely increased even when the electrodes are formed on both sides of the dielectric layer in a manner of sandwiching the dielectric layer therebetween. Therefore, the electrodes can be readily driven. As described above, the electrodes can be readily disposed on both sides of the dielectric layer 17 formed by a vapor deposition method, and visible light well transmits through the layer. Therefore, it can be used in the front substrate.

On the address electrodes 18, a dielectric layer 17b and a protective layer 19 of, for example, MgO are formed. The protective layer 19 emits electrons through ion bombardment so as to accelerate discharge and exerts effects such as reduction of discharge voltages, reduction of delayed discharge, and others. Since all the groups of the electrodes are covered by the protective layer 19 in the structure of this embodiment, the discharge utilizing the effects of the protective layer 19 can be performed regardless of which electrode group functions as a cathode. The thickness of the dielectric layer 17b may be thinner than the thickness of the dielectric layer 17, and the dielectric layer 17b is not always necessary. Also, the thickness of the protective layer 19 is 1 μm or less, and the layer is illustrated as a mere line in the diagram.

On the other hand, on a rear (second) substrate 9, vertical barrier ribs 20 are formed. As shown in the diagram, the lateral width of the vertical barrier ribs 20 is partially varied, which will be described later. Also, phosphor layers 21, 22, and 23 which emit visible light of red, green, and blue when excited by ultraviolet rays generated upon the discharge are coated on the side surfaces and the bottom surfaces of the grooves which are formed by the side surfaces of the vertical barrier ribs 20 and the rear substrate 9.

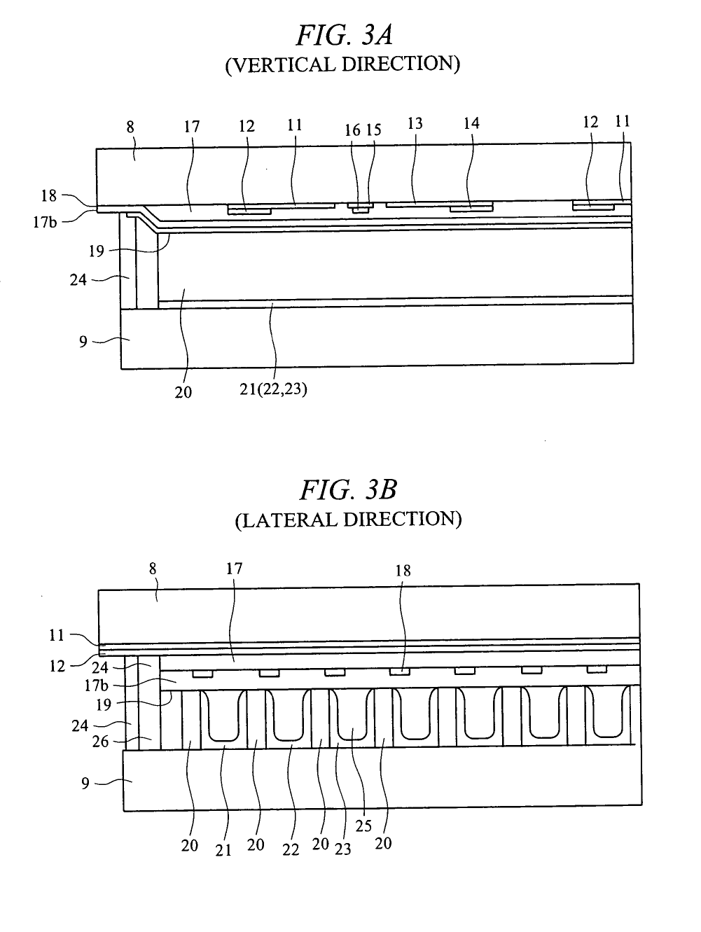

FIG. 3A and FIG. 3B are partial cross-sectional views of the PDP of the first embodiment, wherein FIG. 3A is a vertical cross-sectional view, and FIG. 3B is a lateral cross-sectional view. The front substrate 8 and the rear substrate 8 are bonded to each other by seal 24. Discharge gas of, for example, Ne, Xe, and He is filled in discharge spaces 25 which are divided by the barrier ribs 20 between the front substrate 8 and the rear substrate 9. In this case, the address electrodes 18 are disposed at the positions partially overlapped with the vertical barrier ribs 20.

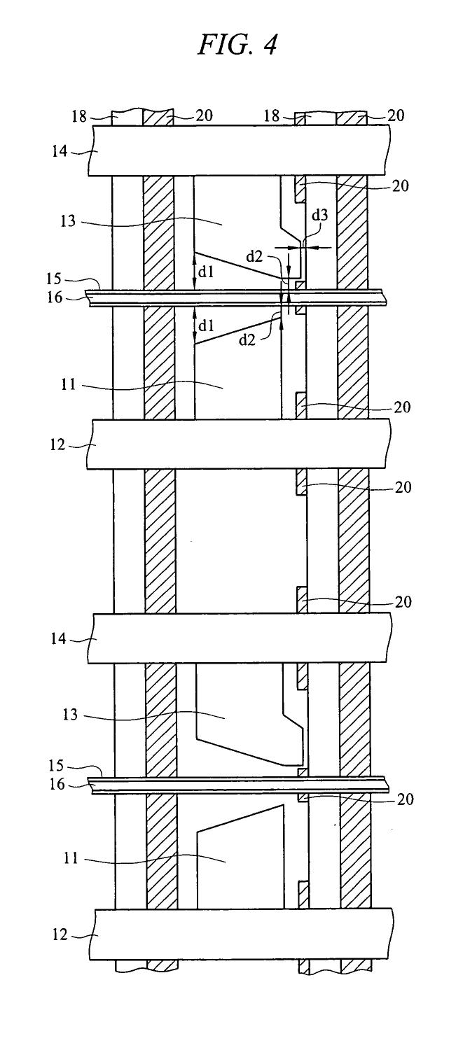

FIG. 4 is a diagram showing the shapes of the electrodes of the plasma display panel 1 of the first embodiment, wherein two pixels in the vertical direction are shown. Such pixels and electrodes are repeatedly disposed in the vertical direction and the lateral direction.

As shown in the diagram, the Y bus electrodes 14 each of which can be individually driven and the X bus electrodes 12 which are driven in common are alternately disposed in parallel to each other. The optically transparent X discharge electrode 11 is protruding from the X bus electrode 12 toward the side of the Y bus electrode to be paired with the X bus electrode. Similarly, the optically transparent Y discharge electrode 13 is protruding from the Y bus electrode 14 toward the side of the X bus electrode to be paired with the Y bus electrode. The Z electrode composed of the optically transparent Z discharge electrode 15 and the Z bus electrode 16 formed of a metal layer are disposed between the X discharge electrode 11 and the Y discharge electrode 13.

The X discharge electrode 11 and the Y discharge electrode 13 are formed so that the distance between the edges thereof which are opposed to the Z electrode and the Z electrode is gradually varied, and the distance between the edges are continuously varied. In this embodiment, the edges form an angle smaller than 90 degrees so that the opposed electrode edges are close to each other on the side of the corresponding address electrode 18 and they are apart from each other by a predetermined distance on the other side. The distances between the opposed edges of the X and Y discharge electrodes 11 and 13 and the Z electrode (inter-electrode distances) are about 50 μm at the close ends (distance d2=50 μm) and 100 μm at the other ends (distance d1=100 μm). Note that these dimensions are only examples because the inter-electrode distance d is determined depending on the relation with the pressure of the discharge gas to be filled according to Paschen's law described later. Also, the opposed edges can be also formed to be like steps so that the inter-electrode distance is gradually varied. In this case, most parts of the electrode edges, except for the stepped parts, are parallel to each other, and the formed angle is about 0 degree.

At the upper and lower ends of the panel, a plurality of bus electrodes without the optically transparent discharge electrodes 11 and 13 are sometimes disposed as dummy electrodes.

The address electrodes 18 which are extending in the vertical direction to be approximately perpendicular to the extending direction of the bus electrodes 12, 14, and 16 are disposed on the dielectric layer 17 which is provided to cover the bus electrodes 12, 14, and 16 and the optically transparent discharge electrodes 11, 13, and 15. A protruding portion protruding from the Y discharge electrode 13 toward the address electrode 18 is provided. A distance d3 between the protruding portion of the Y discharge electrode 13 and the edge of the address electrode 18 which is opposed thereto is smaller than the minimum value d2 of the inter-electrode distance from the X discharge electrode 11 and the Y discharge electrode 13 to the Z electrode. The Y discharge electrode 13 and the address electrode 18 may be approximately overlapped with each other since they are insulated from each other by the dielectric layer 17 interposed therebetween.

The address electrode 18 is disposed so that the address electrode is partially overlapped with the vertical barrier rib 20, more specifically, the address electrode is not overlapped with the rib on the side where the paired X discharge electrode 11 and the Y discharge electrode 13 are provided (left side in the diagram), but overlapped with the rib on the opposite side (right side in the diagram). Furthermore, the vertical barrier rib 20 is laterally protruding at the positions where the X bus electrode 12, the Y bus electrode 14, and the Z electrode (the Z discharge electrode 15 and the Z bus electrode 16) intersect with the address electrode 18. These protruding portions correspond to the parts of the vertical barrier ribs 20 in FIG. 2 where the width thereof is wide. These protruding portions of the vertical barrier ribs 20 prevent the discharge between the X bus electrode 12, the Y bus electrode 14, and the Z electrode and the address electrode 18.

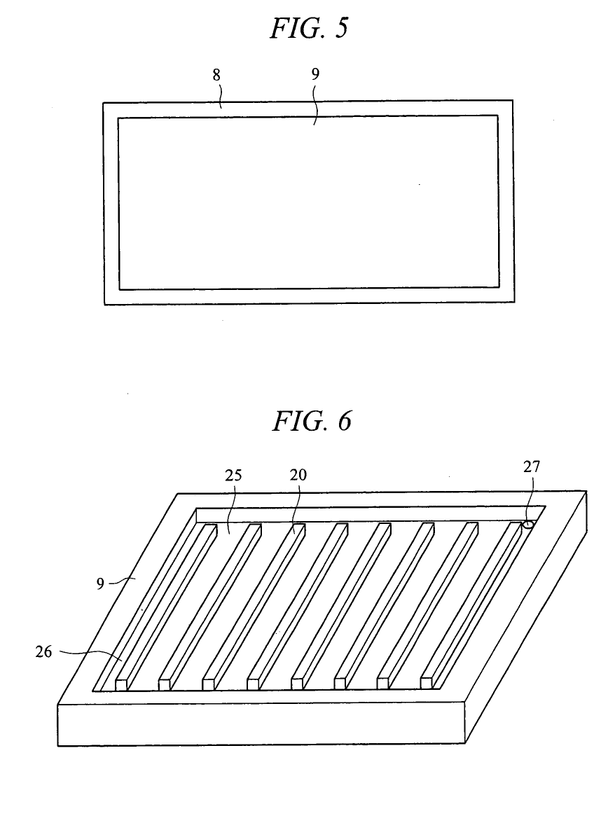

FIG. 5 is a diagram showing the relation between the sizes of the front substrate 8 and the rear substrate 9. The front substrate 8 and the rear substrate 9 are rectangles, and the long sides and the short sides of the front substrate 8 are longer than the long sides and the short sides of the rear substrate 9, respectively.

FIG. 6 is a diagram for explaining the shape of the rear substrate of the first embodiment. The rear substrate 9 is a glass substrate which is grooved through the sandblasting to form the discharge spaces 25 and gas exhaust spaces 26. A gas exhaust hole 27 is a hole which is penetrating the rear substrate 9 from the gas exhaust space 26 and is used for exhausting and filling the discharge gas from the back side after the substrate is bonded with the front substrate 8, and one to several holes are provided as this hole.

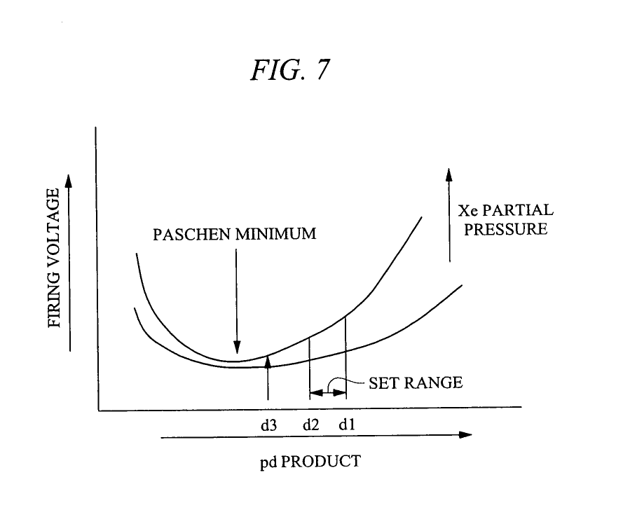

Next, the operation principles of the present invention will be described with reference to FIG. 7.

FIG. 7 is a graph showing the Paschen curve, wherein the horizontal axis represents the product pd of the distance d between two electrodes performing discharge and the pressure p of the discharge gas in the discharge space, and the vertical axis represents the firing voltage. The discharge gas is generally a gas mixture of, for example, neon (Ne), xenon (Xe, and helium (He). When the composition (mixing ratio) of the discharge gas is constant and the inter-electrode distance d or the pressure p of the discharge gas is varied, the firing voltage is varied in accordance with the product pd thereof. This variation shows a downward convex relation as illustrated in FIG. 7. At this time, the point at which the firing voltage becomes lowest is generally called Paschen minimum. For example, when the partial pressure of xenon (Xe) in the mixing ratio of the discharge gas is increased, the firing voltage has a tendency of being increased. However, the voltage variation at the Paschen minimum is small.

Generally, in the AC-type color PDPs, the inter-electrode distance d is designed to have a constant value, and the pd product is set to be positioned on the right side of the Paschen minimum. The reason for that is to select a region where the direction of the voltage variation with respect to the pd product is fixed to one direction of increase or decrease even when the inter-electrode distance d is varied in manufacture. As an example of the pd product, d=100 μm and p=about 6.7×10⁴ Pa can be selected. In this case, if the inter-electrode distance d is set to be constant, the discharge gas pressure at the Paschen minimum is about 1.3×10⁴ Pa. When the discharge gas pressure is set to about 6.7×10⁴ Pa, the inter-electrode distance d at the Paschen minimum is about 20 μm. Therefore, when the discharge gas pressure is set to about 6.7×10⁴ Pa and the inter-electrode distance d is varied between d2=50 μm to d1=100 μm, the variation in the firing voltage is small even if variation occurs in the inter-electrode distance in manufacture.

Meanwhile, since the inter-electrode distance d3 between the Y discharge electrode 13 and the address electrode 18 is smaller than d2, the discharge delay time from the time when voltages are applied to the time when discharge actually occurs is also shortened. This particularly leads to the reduction of the time required for an addressing operation. Therefore, by utilizing the time obtained by shortening the address period, the number of sustain discharges can be increased to improve the luminance or to increase the number of grayscales.

Note that, since the X electrode, the Y electrode, and the Z electrode are provided on the same plane, when variation in manufacture is taken into consideration, the minimum value d2 of the inter-electrode distance is desired to be about 50 μm so that the short-circuit does not occur. Meanwhile, the Y discharge electrode 13 and the address electrode 18 can be closer to each other, since they are formed via the dielectric layer 17. When d3 is made narrower than d2, discharge can be started between the address electrode and the Y discharge electrode 13 at the voltage lower than that between the Y electrode 13 and the Z electrode. Consequently, the address electrode can be driven separately from the Z electrode. As described above, d3 is desired to be narrower than d2 and set to be wider than that of the Paschen minimum (in this case, 20 μm).

In each cell of the PDP, only On/Off can be selected, and lighting luminance cannot be changed, i.e., grayscale display cannot be performed. Therefore, one frame is divided into a plurality of predetermined weighted sub-fields, and grayscale display is performed for each cell by combining the lighting sub-fields in one frame. The sub-fields have the same driving sequence in general.

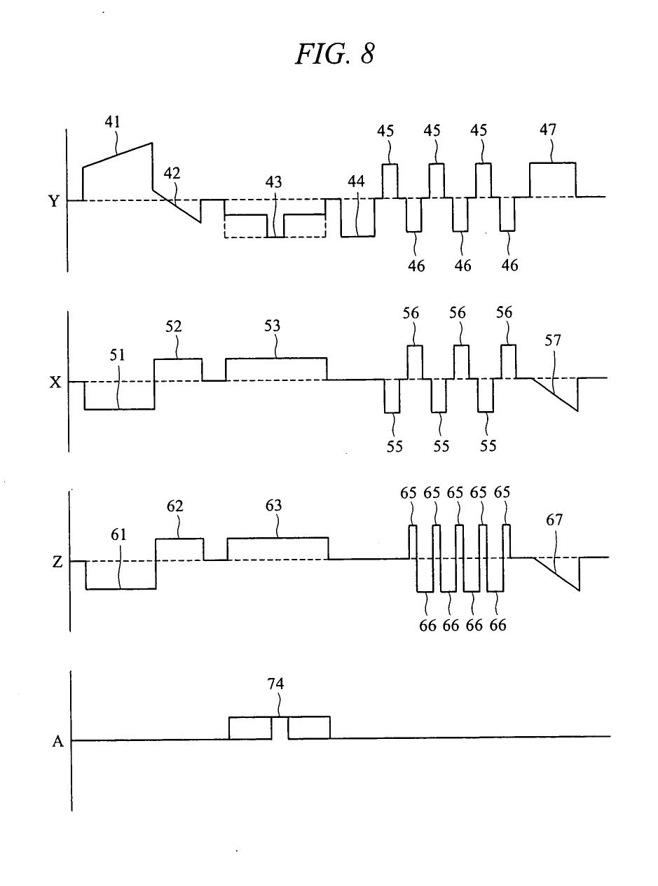

FIG. 8 is a diagram showing driving waveforms of the PDP device of the first embodiment, wherein Y represents a voltage waveform applied to the Y electrodes, X represents a voltage waveform applied to the X electrodes, Z represents a voltage waveform applied to the Z electrodes, and A represents a voltage waveform applied to the address electrodes.

At the beginning of a reset period, 0 V is applied to the address electrodes. In this state, negative reset pulses 51 and 61 are applied to the X electrodes and the Z electrodes, and a positive reset pulse 41 in which the voltage is gradually increased from a predetermined voltage is applied to the Y electrodes. Consequently, in all the cells, discharge is generated between the Z electrodes 15 and 16 and the X discharge electrode 11 and between the Z electrodes 15 and 16 and the Y discharge electrode 13 at first, and the discharge shifts to the discharge between the X discharge electrodes 12 and the Y discharge electrodes 14. Since an obtuse wave in which the voltage is gradually changed is applied here, slight discharge and charge formation are repeated, and wall charge is formed uniformly in all of the cells. The polarity of the formed wall charge is positive in the vicinities of the X discharge electrodes and the Z electrodes and is negative in the vicinities of the Y discharge electrodes. In a panel having a conventional structure in which the address electrodes are formed in the rear substrate 9, high reset voltages are required since charge on the rear substrate side is controlled by the voltages applied to the electrodes disposed on the front substrate 8 side. However, in the panel of this embodiment, the reset voltages can be reduced since the voltages merely control the charges on the front substrate 8 side.

Subsequently, positive compensation voltages 52 and 62 (for example, +Vs) are applied to the X discharge electrodes and the Z electrodes, and a compensation obtuse wave 42 in which the voltage gradually decreases is applied to the Y electrodes. By doing so, since the voltage of the polarity opposite to that of the wall charge which has been formed in the above-described manner is applied by the obtuse wave, the wall charge in the cells is reduced by the slight discharge. Through the process described above, the reset period is completed, and all of the cells are brought into a uniform state.

In the PDP of this embodiment, since the Z electrodes 15 and 16 are provided, the distances between the Z electrodes 15 and 16 and the X discharge electrode 11 and between the Z electrodes 15 and 16 and the Y discharge electrode 13 are narrow, and even low firing voltage generates the discharge, which triggers a shift to the discharge between the X discharge electrode 11 and the Y discharge electrode 13. Therefore, the reset voltages applied between the X electrode and the Y electrode and between the Z electrode and the Y electrode in the reset period can be reduced. Accordingly, the amount of light emitted through the reset discharge which does not relate to the displaying can be reduced, thereby improving the contrast.

In a subsequent address period, the voltages (for example, +Vs) 53 and 63 same as the compensation voltages 52 and 62 are applied to the X electrodes and the Z electrodes, and a predetermined negative voltage is applied to the Y electrodes. In this state, a scan pulse 43 is further sequentially applied to the Y electrodes while changing the positions of the Y electrodes so as to shift the application timing. In accordance with the application of the scan pulse 43, an address pulse 74 is applied to the address electrodes of the cells to be lit. At this time, the polarity of the wall charge formed in the reset period is the same as the polarity of the pulses applied to the Y electrodes and the address electrodes, and the applied voltages can be reduced by virtue of the wall charge. Consequently, address discharge is generated in the cells where the scan pulse 43 and the address pulse 74 are applied at the same time, and the discharge triggers the discharge between the X electrodes and the Y electrodes and between the Z electrodes and the Y electrodes. Through the address discharge, negative wall charge is formed in the vicinities of the X electrodes and the Z electrodes (surface of the dielectric layer), and positive wall charge is formed in the vicinity of the Y electrodes. The wall charge formed here has the polarity opposite to that of the wall charge formed in the reset period. Since the address discharge is not generated in the cells to which the scan pulse or the address pulse is not applied, the wall charge at the time of the reset is maintained. In the address period, the scan pulse is sequentially applied to all of the Y electrodes to carry out the above-described operations, and address discharge is generated in all of the cells to be lit in the entire surface of the panel.

At the end of the address period, a negative charge adjustment pulse 44 is applied only to the Y electrodes. In the cells where the address discharge has been generated, positive wall charge is formed in the vicinities of the Y electrodes, which acts to reduce the voltage of the charge adjustment pulse 44, and thus the discharge is not generated. Meanwhile, in the cells where the address discharge has not been generated, negative wall charge is formed in the vicinities of the Y electrodes, which is added to the voltage of the charge adjustment pulse 44, and thus the discharge is generated. Note that, at this time, since no voltage is applied to the electrodes and the electric potential between the two electrodes is small, the discharge is largely delayed, and the intensity thereof is small. Therefore, the charge adjustment pulse 44 is required to have a length of 20 μs or more, and the wall charge formed after the discharge is small. Consequently, the cells which has been discharged by the charge adjustment pulse 44 is not discharged by the sustain pulse applied in the subsequent sustain discharge period.

In the sustain discharge period, first, a positive sustain discharge pulse 45 having a voltage of +Vs is applied to the Y electrodes, and a negative sustain discharge pulse 55 having a voltage of −Vs is applied to the X electrodes. When the positive sustain discharge pulse 45 having the voltage of +Vs is applied to the Y electrodes and the negative sustain discharge pulse 55 having the voltage of −Vs is applied to the X electrodes for the first time, in the cells where the address discharge is generated, the voltage by the positive wall charge formed in the vicinity of the Y electrode is superimposed on the voltage +Vs, and the voltage by the negative wall charge formed in the vicinity of the X electrode is superimposed on the voltage −Vs. Consequently, sustain discharge is generated between the X discharge electrode 11 and the Y discharge electrode 13. This discharge is terminated when positive charge of the charges generated through the discharge is accumulated as wall charge in the vicinity of the X electrode, negative charge thereof is accumulated as wall charge in the vicinity of the Y electrode, and the voltages by the wall charge reduce the voltages between the X electrode and the Y electrode. When the discharge is terminated, positive wall charge is formed in the vicinity of the X electrode, and negative wall charge is formed in the vicinity of the Y electrode. Since 0 V is applied to the Z electrode, discharge is not generated between the Y discharge electrode and the Z electrode and between the X discharge electrode and the Z electrode, and the wall charge at the time of the reset, i.e., positive wall charge is maintained as the wall charge in the vicinity of the Z electrode.

Subsequently, a positive sustain discharge pulse 56 having the voltage of +Vs is applied to the X electrode, a negative sustain discharge pulse 46 having the voltage of −Vs is applied to the Y electrode, and a short pulse 65 having the voltage of +Vs is applied to the Z electrode. Thereafter, a pulse 66 in which the voltage is varied to the voltage −Vs is applied to the Z electrode. By doing so, the voltage by the negative wall charge formed in the vicinity of the Y electrode is superimposed on the voltage −Vs, and the voltages by the positive wall charge formed in the vicinities of the X electrode and the Z electrode are superimposed on the voltage +Vs. Consequently, discharge is first started between the Z electrode and the Y electrode, and this discharge triggers the discharge between the X electrode and the Y electrode where the distance is wide. Immediately thereafter, the voltage applied to the Z electrode is changed from +Vs to −Vs, and the discharge between the Z electrode and the Y electrode stops. The discharge between the X electrode and the Y electrode is stopped when negative charge is accumulated as wall charge in the vicinity of the X electrode and positive charge is accumulated as wall charge in the vicinity of the Y electrode. However, positive wall charge is formed in the vicinity of the Z electrode since −Vs is applied to the Z electrode at this time. Therefore, when the discharge is terminated, negative wall charge is formed in the vicinity of the X electrode, and positive wall charge is formed in the vicinities of the Y electrode and the Z electrode.

Subsequently, the negative sustain discharge pulse 55 having the voltage of −Vs is applied to the X electrode, the positive sustain discharge pulse 45 having the voltage of +Vs is applied to the Y electrode, and the short pulse 65 having the voltage of +Vs is applied to the Z electrode. Thereafter, the pulse 66 in which the voltage is varied to the voltage −Vs is applied to the Z electrode. By doing so, the voltage by the negative wall charge formed in the vicinity of the X electrode is superimposed on the voltage −Vs, and the voltages by the positive wall charge formed in the vicinities of the Y electrode and the Z electrode are superimposed on the voltage +Vs. Consequently, discharge is first started between the Z electrode and the X electrode, and this discharge triggers the discharge between the X electrode and the Y electrode where the distance is wide. Immediately thereafter, the voltage applied to the Z electrode is changed from +Vs to −Vs, and the discharge between the Z electrode and the X electrode stops. However, since −Vs is applied to the Z electrode at this time, positive wall charge is formed in the vicinity of the Z electrode. Therefore, when the discharge is terminated, positive wall charge is formed in the vicinities of the X electrode and the Z electrode, and negative wall charge is formed in the vicinity of the Y electrode. After this, the sustain discharge is repeated by alternately applying the positive and negative sustain discharge pulses to the X electrode and the Y electrode and applying the pulse having a narrow width to the Z electrode in synchronization with the application of the sustain discharge pulses.

After the sustain discharge period, an erasing pulse 47 is applied to the Y electrode, obtuse-wave erasing pulses 57 and 67 in which voltages are gradually reduced are applied to the X electrode and the Z electrode. By doing so, in the cells where the sustain discharge has been generated, the voltages by the formed wall charge are superimposed to generate the discharge, thereby erasing the wall charge. In the cells where the sustain discharge has not been generated, discharge is not generated since the wall charge is small.

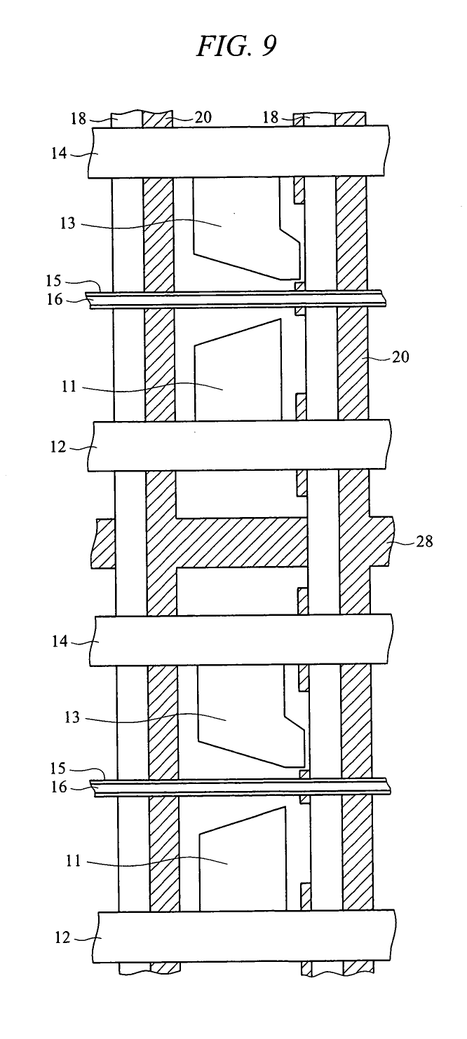

FIG. 9 is a diagram showing a modification example of the barrier ribs of the PDP of the first embodiment. In this modification example, lateral barrier ribs 28 are also provided in addition to the vertical barrier ribs 20. The vertical barrier ribs 20 and the lateral barrier ribs 28 are integrally provided with each other. As shown in the diagram, the lateral barrier rib 28 is disposed between the X bus electrode 12 and the Y bus electrode 14.

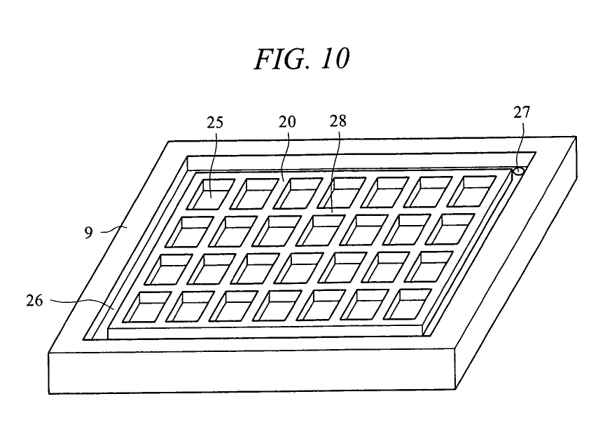

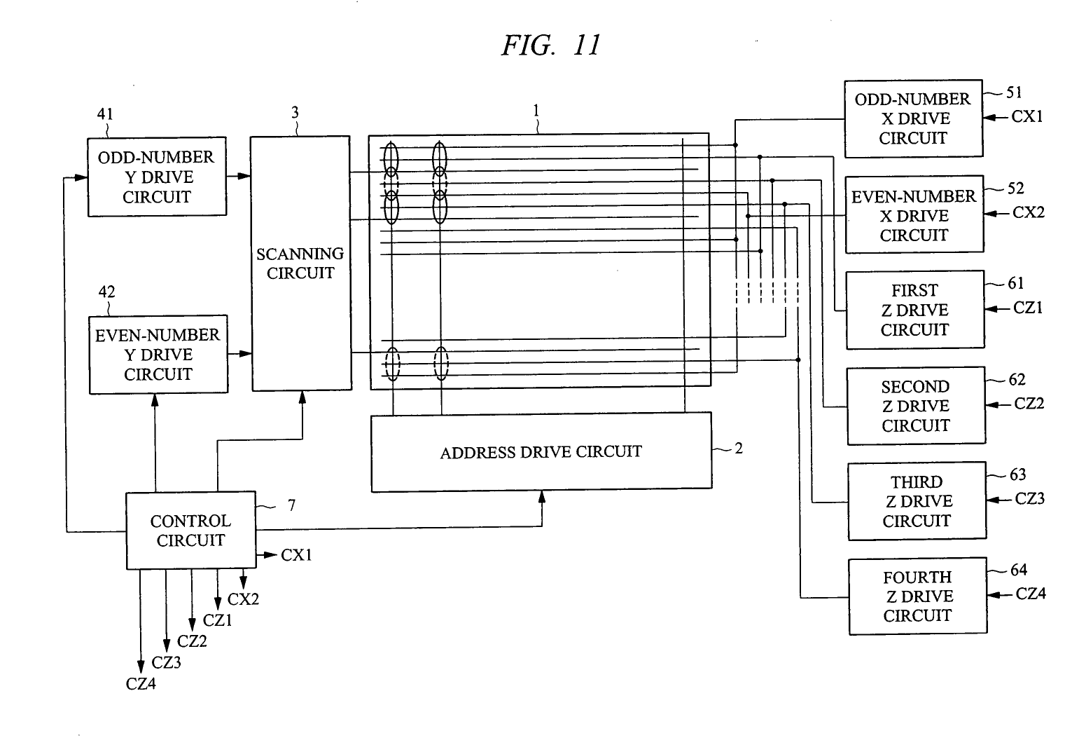

FIG. 10 is a diagram for explaining the structure of the rear substrate in the case where the vertical barrier ribs 20 and the lateral barrier ribs 28 are provided. The lateral barrier ribs 28 are provided in addition to the structure of FIG. 6.

### Second Embodiment

FIG. 11 is a diagram showing the entire structure of a PDP device of the second embodiment of the present invention. The second embodiment is an example in which the present invention is applied to an ALIS-type PDP device disclosed in Patent Document 3. The PDP 1 of the second embodiment is different from the PDP of the first embodiment in that the third electrodes (Z electrodes) are provided between all of the first (X) electrodes and the second (Y) electrodes, and all the spaces between the first (X) electrodes and the second (Y) electrodes are utilized as display lines. Since the ALIS method is disclosed in Patent Document 3, detailed description thereof will be omitted here.

As shown in FIG. 11, the plasma display panel 1 has a plurality of laterally (longitudinally) extending first electrodes (X electrodes) and second electrodes (Y electrodes). The plurality of X electrodes and Y electrodes are alternately disposed, and the number of the lines of the X electrodes is larger than that of the Y electrodes by one. The third electrode (Z electrode) is disposed between the X electrode and the Y electrode. Therefore, the number of the lines of the Z electrodes is twice that of the Y electrodes. Fourth electrodes (address electrodes) are extending in the direction perpendicular to the extending direction of the X, Y, and Z electrodes. In the ALIS method, all of the spaces between the X electrodes and the Y electrodes are utilized as display lines, and odd-numbered display lines and even-numbered display lines are subjected to interlaced display. In other words, the odd-number display lines are formed between the odd-numbered X electrodes and the odd-numbered Y electrodes and between the even-numbered X electrodes and even-numbered Y electrodes, and the even-number display lines are formed between the odd-numbered Y electrodes and the even-numbered X electrodes and between the even-numbered Y electrodes and the odd-numbered X electrodes. One display field is comprised of an odd-number field and an even-number field, wherein the odd-number display lines are displayed in the odd-number field, and the even-number display lines are displayed in the even-number field. Therefore, the Z electrodes are present in each of the odd-number and even-number display lines. In this case, the Z electrodes provided between the odd-numbered X electrodes and the odd-numbered Y electrodes are referred to as the Z electrodes of a first group, the Z electrodes provided between the odd-numbered Y electrodes and the even-numbered X electrodes are referred to as the Z electrodes of a second group, the Z electrodes provided between the even-numbered X electrodes and the even-numbered Y electrodes are referred to as the Z electrodes of a third group, and the Z electrodes provided between the even-numbered Y electrodes and the odd-numbered X electrodes are referred to as the Z electrodes of a fourth group. In other words, the 4p+1th (wherein p is a natural number) Z electrode is the Z electrode of the first group, the 4p+2th Z electrode is the Z electrode of the second group, the 4p+3th Z electrode is the Z electrode of the third group, and the 4p+4th Z electrode is the Z electrode of the fourth group.

As shown in FIG. 11, the PDP device of the second embodiment has the address driving circuit 2 which drives the address electrodes, the scanning circuit 3 which applies scan pulses to the Y electrodes, an odd-number Y driving circuit 41 which applies voltages other than the scan pulse to the odd-numbered Y electrodes in common via the scanning circuit 3, an even-number Y driving circuit 42 which applies voltages other than the scan pulse to the even-numbered Y electrodes in common via the scanning circuit 3, an odd-number X driving circuit 51 which applies voltages to the odd-numbered X electrodes in common, an even-number X driving circuit 52 which applies voltages to the even-numbered X electrodes in common, a first Z driving circuit 61 which drives the Z electrodes of the first group in common, a second Z driving circuit 62 which drives the Z electrodes of the second group in common, a third Z driving circuit 63 which drives the Z electrodes of the third group in common, a fourth Z driving circuit 64 which drives the Z electrodes of the fourth group in common, and the control circuit 7 which controls each of the circuits.

The PDP of the second embodiment has the same structure as the first embodiment except that the X discharge electrodes and the Y discharge electrodes are provided on both sides of the X bus electrodes and the Y bus electrodes, respectively, and the Z electrodes are provided between all of the X bus electrodes and the Y bus electrodes. Therefore, the exploded perspective view thereof will be omitted.

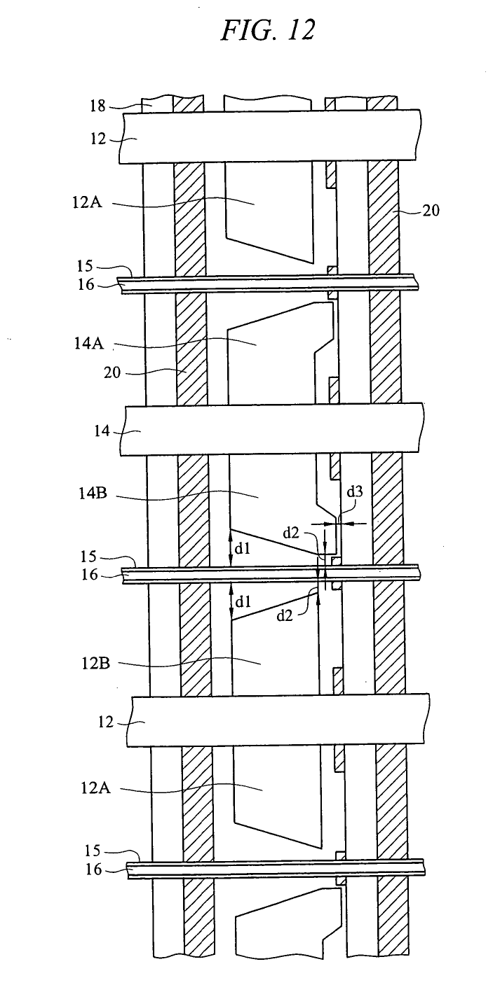

FIG. 12 is a diagram showing the electrode shapes of the second embodiment. The electrode shapes of the second embodiment are different from the electrode shapes of the first embodiment of FIG. 4 in that the X bus electrodes 12 and the Y bus electrodes 14 are alternately disposed in parallel to each other with an equal distance therebetween, the Z electrodes 15 and 16 are disposed at the center of the all spaces therebetween, and an X discharge electrode 12A downwardly extending from the X bus electrode 12, an X discharge electrode 12B upwardly extending from the X bus electrode 12, a Y discharge electrode 14A upwardly extending from the Y bus electrode 14, and a Y discharge electrode 14B downwardly extending from the Y bus electrode 14 are provided. However, other parts are the same as those of the first embodiment.

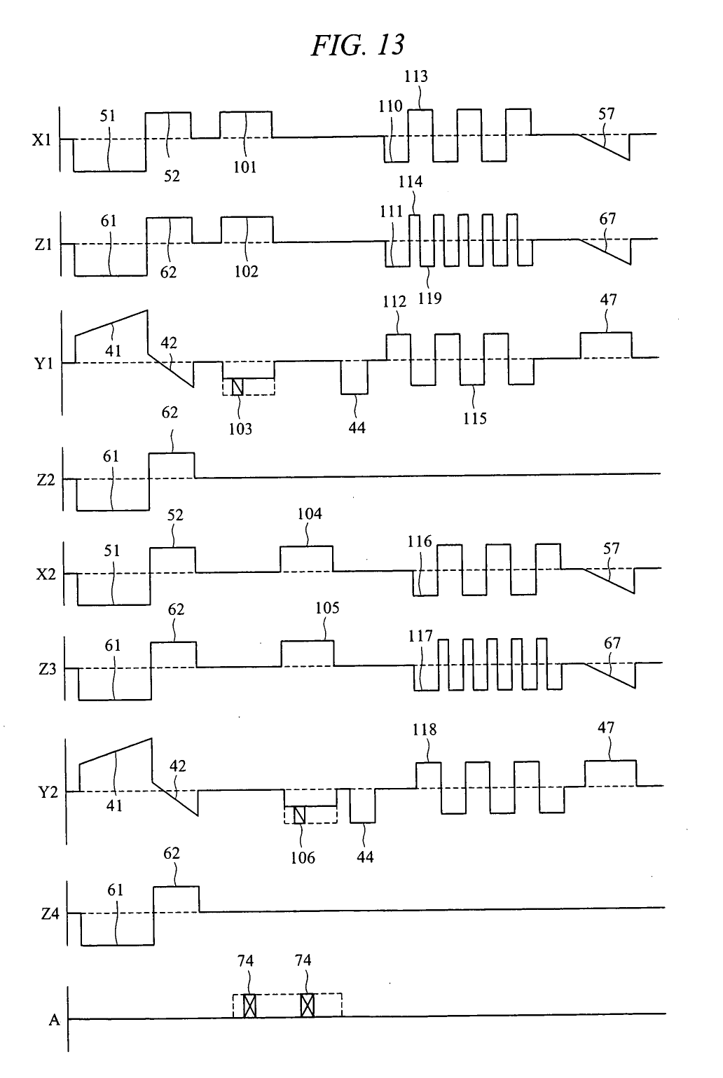

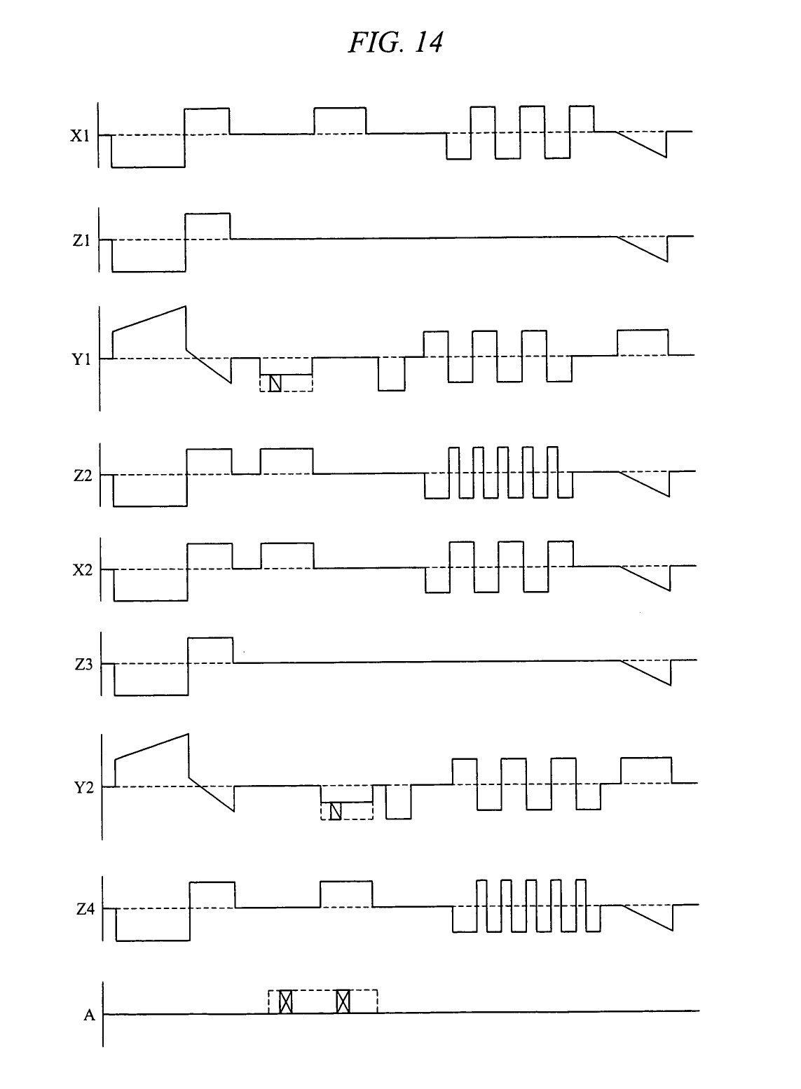

FIG. 13 and FIG. 14 are diagrams showing driving waveforms of the PDP device of the second embodiment, wherein FIG. 13 shows the driving waveforms of the odd-number field, and FIG. 14 shows the driving waveforms of the even-number field. The driving waveforms applied to the X electrodes, the Y electrodes, and the address electrodes are the same as the driving waveforms described in Patent document 3, and a driving waveform same as that applied to the Z electrode in the first embodiment is applied to the Z electrode which is provided between the X electrode and the Y electrode where discharge is to be performed. A slightly different driving waveform is applied to the Z electrode which is provided between the Z electrode and the Y electrode where no discharge is to be performed. Note that, in FIG. 13 and FIG. 14, the pulses having the same functions as those of FIG. 8 are denoted by the same reference numerals.

The driving waveforms in the reset period of the second embodiment are the same as the driving waveforms of the first embodiment, and all of the cells are brought into a uniform state in the reset period.

In the first half of the address period, predetermined voltages (for example, +Vs) 101 and 102 are applied to the odd-numbered X electrode X1 and the Z electrode Z1 of the first group, the even-numbered X electrode X2, the even-numbered Y electrode Y2, and the Z electrodes Z2 to Z4 of the second to fourth groups are set at 0 V, and a predetermined negative voltage is applied to the odd-numbered Y electrode Y1. In this state, a scan pulse 103 is further applied to the odd-numbered Y electrode Y1. In accordance with the application of the scan pulse 103, the address pulse 74 is applied to the address electrode of the cell to be lit. Consequently, a discharge is generated between the odd-numbered Y electrode Y1 to which the scan pulse has been applied and the address electrode to which the address pulse has been applied, and this discharge triggers the discharge between the odd-numbered X electrode X1 and the odd-numbered Y electrode Y1 and between the Z electrode Z1 of the first group and the odd-numbered Y electrode Y1. At this time, since 0 V is applied to the even-numbered X electrode X2 and the Z electrode Z2 of the second group, discharge is not generated between the odd-numbered Y electrode Y1 and the even-numbered X electrode X2 and between the odd-numbered Y electrode Y1 and the Z electrode Z2 of the second group. Through this address discharge, negative wall charge is formed in the vicinities of the odd-numbered X electrode X1 and the Z electrode Z1 of the first group (on the surface of the dielectric layer), and positive wall charge is formed in the vicinity of the odd-numbered Y electrode Y1. Since the address discharge is not generated in the cell to which the scan pulse or the address pulse is not applied, the wall charge at the time of the reset is maintained. In the first half of the address period, the scan pulse is sequentially applied to all of the odd-numbered Y electrodes Y1 so as to perform the above-described operations.

In the latter half of the address period, the predetermined voltages 104 and 105 are applied to the even-numbered X electrode X2 and the Z electrode Z3 of the third group, the odd-numbered X electrode X1, the odd-numbered Y electrode Y1, and the Z electrodes Z1, Z2, and Z4 of the first, second and fourth groups are set at 0 V, and a predetermined negative voltage is applied to the even-numbered Y electrode Y2. In this state, a scan pulse 106 is further applied to the even-numbered Y electrode Y2. In accordance with the application of the scan pulse 106, the address pulse 74 is applied to the address electrode of the cell to be lit. Consequently, a discharge is generated between the even-numbered Y electrode Y2 to which the scan pulse has been applied and the address electrode to which the address pulse has been applied, and this discharge triggers the discharge between the even-numbered X electrode X2 and the even-numbered Y electrode Y2 and between the Z electrode Z3 of the third group and the even-numbered Y electrode Y2. Through this address discharge, negative wall charge is formed in the vicinities of the even-numbered X electrode X2 and the Z electrode Z3 of the third group, and positive wall charge is formed in the vicinity of the even-numbered Y electrode Y2. In the latter half of the address period, the scan pulse is applied sequentially to all of the even-numbered Y electrodes Y2 so as to perform the above-described operations.

The addressing operations between the odd-numbered X electrodes X1 and the odd-numbered Y electrodes Y1 and between the even-numbered X electrodes X2 and the even-numbered Y electrodes Y2, i.e., the addressing operations on the odd-numbered display lines are completed in the above-described manner. In the cells where the address discharge has been performed, positive wall charge is formed in the vicinities of the odd-numbered and even-numbered Y electrodes Y1 and Y2, and negative wall charge is formed in the vicinities of the odd-numbered and even-numbered X electrodes X1 and X2 and the Z electrodes Z1 and Z3 of the first and third groups.

At the end of the address period, the charge adjustment pulse 44 is applied to the Y electrodes.

In the sustain discharge period, a negative sustain discharge pulse 110 having the voltage of −Vs is first applied to the odd-numbered X electrode X1, a positive sustain discharge pulse 112 having the voltage of +Vs is applied to the odd-numbered Y electrode Y1, and a pulse 111 having the voltage of −Vs is applied to the Z electrode Z1 of the first group. 0 V is applied to the even-numbered X electrode X2, the even-numbered Y electrode Y2, and the Z electrode Z3 of the third group. During the sustain discharge period, 0 V is applied to the Z electrodes Z2 and Z4 of the second and the fourth groups. The voltage by the negative wall charge is superimposed on the voltage −Vs in the odd-numbered X electrode X1, the voltage by the negative wall charge is superimposed on the voltage −Vs in the Z electrode Z1 of the first group, and the voltage by the positive wall charge is superimposed on the voltage +Vs in the odd-numbered Y electrode Y1, and thus, large voltages are applied therebetween. Consequently, slight discharge is first started between the Z electrode Z1 of the first group and the odd-numbered Y electrode Y1 where the distance therebetween is narrow, and this discharge triggers a shift to the discharge between the odd-numbered X electrode X1 and the odd-numbered Y electrode Y1 where the distance therebetween is wide. When this discharge is finished, positive wall charge is formed in the vicinities of the odd-numbered X electrode X1 and the Z electrode Z1 of the first group, and negative wall charge is formed in the vicinity of the odd-numbered Y electrode Y1.

The voltage Vs is applied to the odd-numbered Y electrode Y1, and 0 V is applied to the Z electrode Z2 of the second group. Consequently, the voltage by the positive wall charge is superimposed in the odd-numbered Y electrode Y1, and the voltage between the odd-numbered Y electrode Y1 and the Z electrode Z2 of the second group increases. However, since the voltage applied to the Z electrode Z2 of the second group is 0 V and wall charge is not formed in the Z electrode Z2 of the second group, the voltage by the wall charge is not superimposed. Therefore, the voltage does not reach the firing voltage, and discharge is not generated. Similarly, discharge is not generated also between the even-numbered X electrode X2 and the Z electrode Z2 of the second group. In this case, the voltage applied to the Z electrode Z2 of the second group is required to be set at a voltage which does not generate the discharge. However, the voltage applied to the Z electrode Z2 of the second group is desired to be lower than the voltage +Vs which is applied to the adjacent odd-numbered Y electrode Y1 and even-numbered X electrode X2. This is for the following reason. When a sustain discharge is generated between the odd-numbered X electrode X1 and the odd-numbered Y electrode Y1, mobile electrons move from the odd-numbered X electrode X1 to the odd-numbered Y electrode Y1. However, if the voltage of the Z electrode Z2 of the second group is the same as the voltage of the odd-numbered Y electrode Y1, the electrons directly move to the Z electrode Z2 of the second group, and then reach the even-numbered X electrode X2. In such a case, when the sustain discharge pulse of the opposite polarity is applied next, an erroneous discharge is generated and a display error occurs. On the other hand, when the voltage of the Z electrode Z2 of the second group is set at 0 V like the present embodiment, since it is lower than the voltage of the odd-numbered Y electrode Y1, the movement of the electrons can be prevented, and the occurrence of erroneous discharges between adjacent display lines can be prevented.

The above-described conditions are true of the Z electrode Z4 of the fourth group provided between the even-numbered Y electrode Y2 and the odd-numbered X electrode X1.

Then, positive sustain discharge pulses 113 and 118 having the voltage of +Vs are applied to the odd-numbered X electrode X1 and the even-numbered Y electrode Y2, negative sustain discharge pulses 115 and 116 having the voltage of −Vs are applied to the odd-numbered Y electrode Y1 and the even-numbered X electrode X2, a positive short pulse 114 having the voltage +Vs is applied to the Z electrode Z1 of the first group, and the negative pulse 118 having the voltage of −Vs is applied to the Z electrode Z3 of the third group. As described above, in the odd-numbered X electrode X1 and the Z electrode Z1 of the first group, positive wall charge has been formed by the previous sustain discharge, and the voltages caused by that is superimposed on the respective voltages +Vs, and in the odd-numbered Y electrode Y1, the voltage by the negative wall charge by the previous sustain discharge is superimposed on the voltage −Vs. Consequently, a large voltage is applied therebetween. Furthermore, in the even-numbered X electrode X2 and the Z electrode Z3 of the third group, negative wall charge formed when the addressing is completed is maintained and the voltage by the wall charge is superimposed on the voltage −Vs, and in the even-numbered Y electrode Y2, the positive wall charge formed when the addressing is completed is maintained and the voltage by the wall charge is superimposed on the voltage +Vs. Consequently, a large voltage is applied therebetween. As a result, slight discharge between the Z electrode Z1 of the first group and the odd-numbered Y electrode Y1 and between the Z electrode Z3 of the third group and the even-numbered Y electrode Y2 where the distances therebetween are narrow is started, and the discharge triggers shifts to discharge between the odd-numbered X electrode X1 and the odd-numbered Y electrode Y1 and between the even-numbered X electrode X2 and the even-numbered Y electrode Y2 where the distances therebetween are wide.

After the positive short pulse 114 is applied to the Z electrode Z1 of the first group, a pulse 119 having the voltage of −Vs is applied to the Z electrode Z1 of the first group. Therefore, when main discharge between the odd-numbered X electrode X1 and the odd-numbered Y electrode Y1 is finished, negative wall charge is formed in the vicinity of the odd-numbered X electrode X1, and positive wall charge is formed in the vicinities of the Z electrode Z1 of the first group and the odd-numbered Y electrode Y1. Also, positive wall charge is formed in the vicinities of the even-numbered X electrode X2 and the Z electrode Z3 of the third group, and negative wall charge is formed in the vicinity of the even-numbered Y electrode Y2.

Then, a negative sustain discharge pulse having the voltage of −Vs is applied to the odd-numbered X electrode X1 and the even-numbered Y electrode Y2, a positive sustain discharge pulse having the voltage of +Vs is applied to the odd-numbered Y electrode Y1 and the even-numbered X electrode X2, and a positive short pulse having the voltage of +Vs is applied to the Z electrode Z1 of the first group and the Z electrode Z3 of the third group. By doing so, the discharge between the odd-numbered X electrode X1 and the Z electrode Z1 of the first group triggers the sustain discharge between the odd-numbered X electrode X1 and the odd-numbered Y electrode Y1. Similarly, the discharge between the even-numbered Y electrode Y2 and the Z electrode Z3 of the third group triggers the sustain discharge between the even-numbered X electrode X2 and the even-numbered Y electrode Y2. Thereafter, the sustain discharge is repeated by applying the sustain discharge pulses while reversing the polarities thereof.

As described above, the first sustain discharge is generated only between the odd-numbered X electrode X1 and the odd-numbered Y electrode Y1, but is not generated between the even-numbered X electrode X2 and the even-numbered Y electrode Y2. Therefore, at the end of the sustain discharge period, sustain discharge is generated only between the even-numbered X electrode X2 and the even-numbered Y electrode Y2 and not generated between the odd-numbered X electrode X1 and the odd-numbered Y electrode Y1 so as to match the number of the sustain discharges.

After the sustain discharge period, similar to the first embodiment, the erasing pulses 47, 57, and 67 are applied.

In the foregoing, the driving waveforms of the odd-number field have been described. In the driving waveforms of the even-number field, the same driving waveforms as those in the odd-number field are applied to the odd-numbered and even-numbered Y electrodes Y1 and Y2, the driving waveform applied to the even-numbered X electrode X2 of the odd-number field is applied to the odd-numbered X electrode X1, the driving waveform applied to the odd-numbered X electrode X1 of the odd-number field is applied to the even-numbered X electrode X2, the waveform applied to the Z electrode Z2 of the second group of the odd-number field is applied to the Z electrode Z1 of the first group, the driving waveform applied to the Z electrode Z1 of the first group of the odd-number field is applied to the Z electrode Z2 of the second group, the driving waveform applied to the Z electrode Z4 of the fourth group of the odd-number field is applied to the Z electrode Z3 of the third group, and the driving waveform applied to the Z electrode Z3 of the third group of the odd-number field is applied to the Z electrode Z4 of the fourth group.

As described above, according to the present invention, driving circuits in a PDP device can be composed of elements having comparatively low driving performance, and it is possible to provide a plasma display panel which can realize a PDP device having good display quality at low cost.

What is claimed is:

1. A plasma display panel comprising:
a first substrate; a second substrate; and discharge gas filled between said first and second substrates,
wherein said first substrate includes: a group of first electrodes for performing sustain discharge and a group of second electrodes which can be independently driven, said first and second electrodes being alternately disposed approximately in parallel to each other; a group of third electrodes located between said first and second electrodes; a dielectric layer covering said groups of the first to third electrodes; a group of fourth electrodes provided on said dielectric layer so as to intersect with said first to third electrodes; and a protective layer provided so as to cover said dielectric layer and said group of the fourth electrodes, and
said second substrate includes: barrier ribs provided in parallel to said fourth electrode so as to divide at least said
first to third electrodes in the extending direction thereof; and phosphors for emitting light when excited by ultraviolet rays.

2. The plasma display panel according to claim 1,
wherein said first electrode is comprised of a first discharge electrode through which visible light can pass and a first bus electrode having an electrical resistance value lower than that of the first discharge electrode, and said second electrode is comprised of a second discharge electrode through which visible light can pass and a second bus electrode having an electrical resistance value lower than that of the second discharge electrode.

3. The plasma display panel according to claim 1,
wherein said groups of the first and second electrodes and said group of the third electrodes are disposed on the same plane.

4. The plasma display panel according to claim 2,
wherein said barrier ribs are provided so as to cover portions where said first bus electrode, said second bus electrode, and said third electrode intersect with said fourth electrode and vicinities of the portions.

5. The plasma display panel according to claim 2,
wherein said first discharge electrode, said second discharge electrode, and said third electrode have the same shapes in each cell, and distances from said first discharge electrode and said second discharge electrode to said third electrode are gradually varied in each cell.

6. The plasma display panel according to claim 5,
wherein a minimum distance from said first discharge electrode and said second discharge electrode to said third electrode in each cell is 50 μm or less, and a product of pressure of said filled discharge gas and said minimum distance is larger than Paschen minimum.

7. The plasma display panel according to claim 5,
wherein a maximum distance from said first discharge electrode and said second discharge electrode to said third electrode in each cell is 100 μm or more.

8. The plasma display panel according to claim 5,
wherein a minimum distance from said first discharge electrode and said second discharge electrode to said third electrode in each cell is positioned on a side where said fourth electrode in the cell is disposed.

9. The plasma display panel according to claim 2,
wherein a distance between said second discharge electrode and said fourth electrode is narrower than distances from said first discharge electrode and said second discharge electrode to said third electrode.

10. The plasma display panel according to claim 1,
wherein said dielectric layer covering said groups of the first to third electrodes is composed of a silicon compound formed through a vapor deposition process.

11. The plasma display panel according to claim 1,
wherein long sides and short sides of said second substrate are shorter than long sides and short sides of said first substrate, respectively.

12. The plasma display panel according to claim 1,
wherein said discharge gas contains at least neon (Ne) and xenon (Xe), and the mixing ratio of xenon is 10 percent or more.

13. A plasma display device comprising:
the plasma display panel according to claim 1; and
first to fourth drive circuits for applying voltages to said groups of the first to fourth electrodes,
wherein, in a sustain discharge period, in synchronization with application of the voltages from said first and second drive circuits to said groups of the first and second electrodes, said third drive circuit applies a voltage, which generates a discharge between said group of the third electrodes and said group of the first electrodes or between said group of the third electrodes and said group of the second electrodes, to said group of the third electrodes, in order to repeat discharges between said group of the first electrodes and said group of the second electrodes.

14. A plasma display device comprising:
the plasma display panel according to claim 9; and
first to fourth drive circuits for applying voltages to said groups of the first to fourth electrodes,
wherein, in an address period, when said fourth drive circuit applies a voltage to said group of the fourth electrodes, discharge is generated between said fourth electrode and said second electrode, and said discharge between said fourth electrode and said second electrode triggers discharge between said second electrode and said first electrode.
